(19) United States
(12) Patent Application Publication
(10) Pub. No.: US 2006/0242885 A1
(43) Pub. Date: Nov. 2, 2006

(54) Convertible fly rod

(76) Inventor: Roger C. Hall, Eugene, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/117,831

(22) Filed: Apr. 29, 2005

(51) Int. Cl. A01K 87/00

(52) U.S. Cl. 43/18.1 CT; 43/18.1 R

(57) ABSTRACT

A flycasting rod that is convertible between a first configuration suitable for use while holding the rod in only one hand while casting flies, and a second configuration in which the rod includes two separate hand grips and an extension of the shaft of the rod, that is suitable for holding the rod with both hands and casting flies using the Spey techniques.

### BACKGROUND OF THE INVENTION

The present invention relates to fishing rods, and in particular relates to a flycasting rod convertible between two different configurations for different methods of flycasting.

In fly fishing a long, flexible, yet moderately stiff, tapered rod is used, together with a line that is heavy enough so that when the line is extended from the tip of the rod its weight can be applied to bend the rod in the process of casting a fly attached to the outer end of the line. By moving the rod, the line can be placed into motion, so that when the rod is stopped the line, continuing to move, flexes the tip of the rod. Thereafter, release of the potential energy stored in the bent rod accelerates the line in a different direction, together with a leader and a fly attached to the outer end of the leader. Further movement of the rod by a skilled caster can throw the line far enough to place the fly in a desired target location as far as 30 yards away.

Conventionally, a fly rod is held in one hand while casting a fly, and, where space is available for an overhead cast, a backcast is used to accelerate the line rearwardly and thereafter to apply the kinetic energy of the rearwardly moving line to the rod, so that properly timed forward movement of the rod thereafter can store the kinetic energy from the rearwardly moving line, plus additional energy applied by the angler in moving the rod forward, in the rod as potential energy, by further bending of the rod. Properly timed forward movement of the rod changes the direction of movement of the line, accelerating it forward as the rod straightens itself, throwing the line toward the place where it is desired for the fly to land. Various techniques of hauling on the line and releasing it at proper times during the casting movements can add to the distance to which a fly can be cast.

Where there is a long distance between a place where an angler can stand to cast and the place where it is desired to place a fly, a conventional overhead cast requires a long open space behind the angler in which to make the backcast mentioned above. Lacking such a space, as where an angler must remain close to a steep or tree-covered bank while casting across a wide expanse of water, another type of cast, such as a roll cast, might be used, but such other casting techniques are generally less efficient than an overhead cast in reaching long distances.

Referring now to the drawings, FIG. 1 shows a prior art conventional fly rod 10 having a tip section 12, an intermediate section 14, and a butt section 16 that includes a hand grip 18 and a reel seat 20 on which is mounted a typical fly fishing reel 22. The fly rod 10 may have a length in the range of six feet to nine or ten feet, and is typically about nine feet long. The grip 18 is suitable for being held by only one hand, with a length 24 of the grip 18 typically being about six or seven inches.

A typical fly rod 10 may have fewer or more sections than the three sections 12, 14, and 16 shown in FIG. 1, with each section being joined to an adjacent section by a joint 26 or 28 which may have any one of several conventional configurations generally intended to connect rod sections to one another securely yet permit them to be separated easily, so that the rod can be carried more conveniently when it is not in use. Such a fly rod 10 may be made of many different types of material such as wood, bamboo, or composite materials including fibers of glass, graphite, or other strong synthetic materials, and the rod is usually tapered from a greatest thickness in the butt section 16 to a minimal thickness in the tip section 12, in order to bend under a desired amount of force so that the rod can be used to cast a line of a desired weight.

One way that has been found effective in casting flies over long distances is the use of a longer rod. One such type of a longer rod is known as a Spey rod, named for the River Spey in Scotland where use of such a rod originates, and a particular manner of handling a long fly line using such a rod, known as Spey casting, requires no space behind the angler. A shortcoming of such a casting technique, however, is that it requires a very long fly rod, which is heavier than a conventional rod used with one hand.

Referring to FIG. 2, a typical Spey flycasting rod 30 has four separable sections, a tip section 32, a forward intermediate section 34, a rearward intermediate section 36, and a butt section 38, all interconnected separably with one another by joints 40, 42, and 44 of the appropriate sizes, although a Spey rod may have more or fewer sections.

A Spey rod 30 typically has a length greater than nine feet and typically in the range from 12 feet to 14 feet, although Spey rods shorter than nine feet and as long as 16 feet are also known. The number of sections of such a rod is usually chosen to result in each section being of a size allowing the disassembled rod to be carried conveniently. A Spey rod 30, 15 feet long, may thus have five or even six sections.

A Spey rod is designed to be held by both hands while casting. A rear hand grip is located behind the reel seat, and a forward grip, located ahead of the reel seat, is usually at least about twice as long as a grip such as the grip 18 on a fly rod intended to be held in one hand. The Spey rod 30 thus includes a front grip 46 whose length 48 is greater than the length 24 of the grip 18 of the fly rod 10 and may be in the range of 12 inches to 18 inches, for example. Such a long front grip 46 allows the user to grasp the forward part of the grip while casting, and to hold a different part of the grip 46 while playing a fish.

Located immediately rearward of the front grip 46 is a reel seat 50, on which a fly-fishing reel 52 is mounted. Typically a reel 52 used with a Spey rod 30 is larger than the reel 22 used on a shorter fly rod 10 for one-handed use, since a greater length of line and often a heavier line is used with a Spey rod 30 than with a fly rod 10 for one-handed use.

Located behind the reel seat 50 is a rear hand grip 54, whose length 56 is typically less than the length 24 of the grip 18 of a one-handed fly rod 10, and may be about five inches, for example.

Because of their larger size, Spey fly rods are significantly more expensive than a conventional fly rod intended for use in one-handed casting techniques. A Spey rod is infrequently needed, and is often too large to be used well in small streams. A conventional one-handed rod can be used with less effort because of its lighter weight, and therefore may be preferred where it can be used.

Many anglers are therefore reluctant or unable to justify the greater cost of a Spey fly rod that is useful only on relatively infrequent occasions. An angler may also be reluctant to carry a second rod, particularly when the second rod is a long and relatively heavy Spey rod, where most casting can be accomplished using a single-handed rod. However, in some circumstances it would be very desirable to be able to take advantage of the capabilities of a Spey rod easily, quickly, and at a low additional cost relative to that of a conventional rod of at least good quality, and to do so without having to carry a large second rod in addition to a conventional rod.

Kiser U.S. Pat. No. 5,974,722 shows a fishing rod that is convertible, between a very short configuration intended for use in ice fishing and a longer configuration for use in more conventional fishing.

Reimer U.S. Pat. No. 4,183,163 discloses a multi-section fishing rod with a replaceable handle and butt section and a replaceable tip section, so that the rod can be used in an extra long configuration, for dangling a line in “sneak fishing,” or in a shorter configuration for use in casting flies for salmon.

Livingston U.S. Pat. No. 4,067,133 discloses a system of adaptors to be utilized on a front end of a rear section of a fishing rod to permit installation of tip sections of various lengths, to convert, for example, long multi-section casting rods into short rods for use in deep sea fishing. A conventional surf casting butt section with a long hand grip portion is used in each configuration of the rod shown.

The prior art, however, does not adequately address the issues mentioned above. What is desired, then, is a fly rod that is easily convertible, between a configuration useful for conventional one-handed flycasting and a Spey rod configuration, in which the rod can be held by both hands for long distance casting or casting in places where there is insufficient room for a backcast.

### SUMMARY OF THE INVENTION

The present invention answers the aforementioned needs by providing a multi-section fly rod that is convertible quickly and easily between two configurations.

As a first preferred embodiment a convertible fly rod includes a forward portion mated, in a first configuration, with a short rear end portion including a conventional single-hand grip and a reel seat. A rod joint is located a short distance ahead of the reel seat, as at the front end of the conventional single-hand grip, so that the short rear end portion of the rod is securely fastened to but easily removable from the forward portion. A Spey conversion rear end portion, preferably including a long front grip, a reel seat, a rear hand grip behind the reel seat, and an extension shaft forward of the long front grip, can be mated similarly with the forward portion of the rod in place of the short rear end portion, to convert it to a configuration suitable for two-handed Spey style casting.

In one embodiment of such a convertible rod a rear hand grip is fastened removably to a rear portion of a reel seat by a joint which can easily be disconnected.

In one embodiment such a convertible rod includes several rod sections connected with one another by conventional rod joints which can be disconnected to permit the rod to be carried easily in a compact configuration.

The foregoing and other objectives, features, and advantages of the invention will be more readily understood upon consideration of the following detailed description of the preferred embodiments, taken in conjunction with the accompanying drawings.

### BRIEF DESCRIPTION OF THE SEVERAL VIEWS OF THE DRAWINGS

FIG. 1 is a view of a conventional multi-section fly rod intended to be held by one hand while casting a fly.

FIG. 2 is a view of a multi-section Spey fly rod intended to be held by two hands while casting a fly by use of a Spey casting technique.

FIG. 3 is a view of an exemplary convertible fly rod embodying the present invention, in a first configuration in which the rod can be held in one hand to cast a fly using conventional flycasting techniques.

FIG. 4 is a view of the fly rod shown in FIG. 3, converted to a longer configuration suitable for being held by two hands for use of Spey flycasting techniques.

FIG. 5 is a partly exploded view of a convertible fly rod which is an alternative embodiment of the rod shown in FIGS. 3 and 4, shown in a configuration suitable for being held by two hands while casting a fly using Spey casting techniques.

### DETAILED DESCRIPTION OF PREFERRED EMBODIMENTS

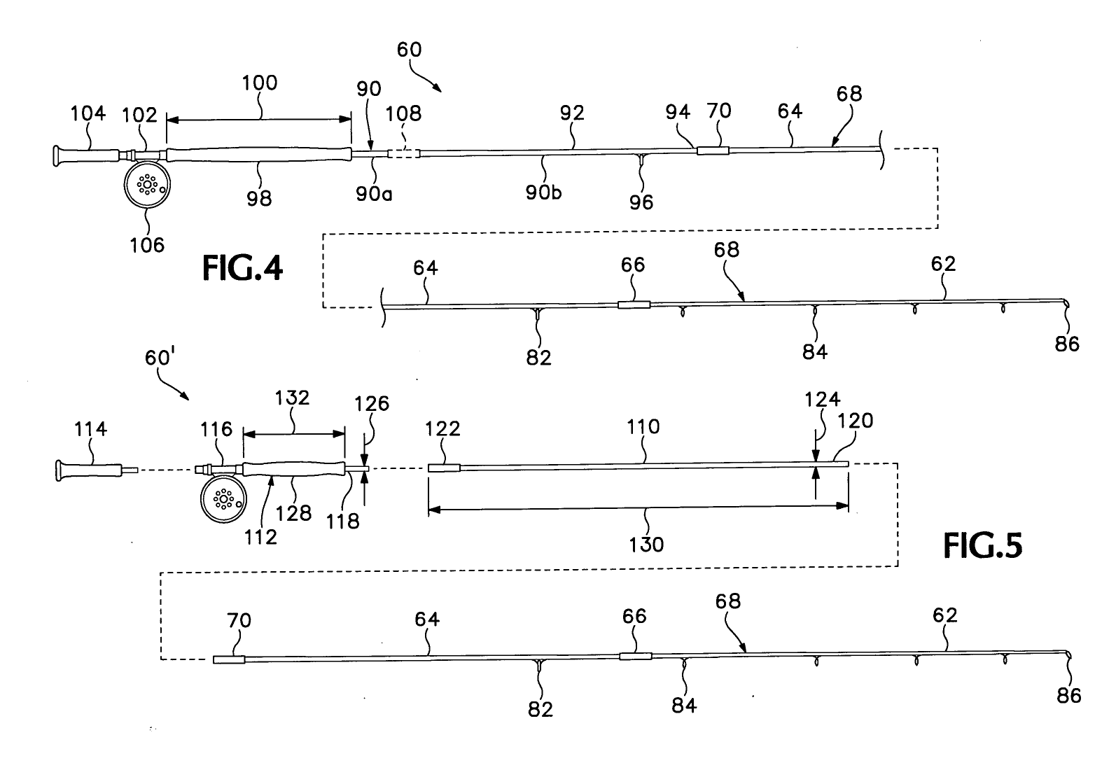

Referring now to FIGS. 3 and 4 of the drawings which form a part of the disclosure herein, a convertible rod 60 is shown in FIG. 3 in a first configuration suitable for use as a conventional fly rod to be held in one hand during casting, similar to the fly rod 10 described previously. A tip section 62 and an intermediate section 64, interconnected separably with each other by a conventional rod joint 66, together constitute a forward rod portion 68 of the rod 60. A rear connecting member 70, which may be one of the mating parts of a conventional rod joint, is located at the rear end of the forward rod portion 68. The forward rod portion 68 may instead be divided into a larger number of shorter sections, and thus may have one or two additional intermediate sections interconnected by rod joints, if it is desired for the convertible rod 60 to form a smaller package for greater convenience in carrying it disassembled.

A short rear end portion 72 includes a grip 74 generally similar to the grip 18 of the rod 10 described above, and has a reel seat 76 on which a reel 78 of an appropriate size may be mounted. The short rear end portion 72 is mated removably with the forward rod portion 68 by a front connector member 80 such a rod joint part built to mate with the rear connecting member 70 located at the front of the grip 74, so that the entire short rear end portion 72 may have an overall length, including the front connecting section 80, of as little as about nine or ten inches. The fly rod 60 assembled as shown in FIG. 3 has the usual balance and feel of a conventional fly rod of that length and designed for the particular line weight for which the rod 60 is intended to be used in the conventional configuration shown in FIG. 3, using conventional one-handed casting techniques.

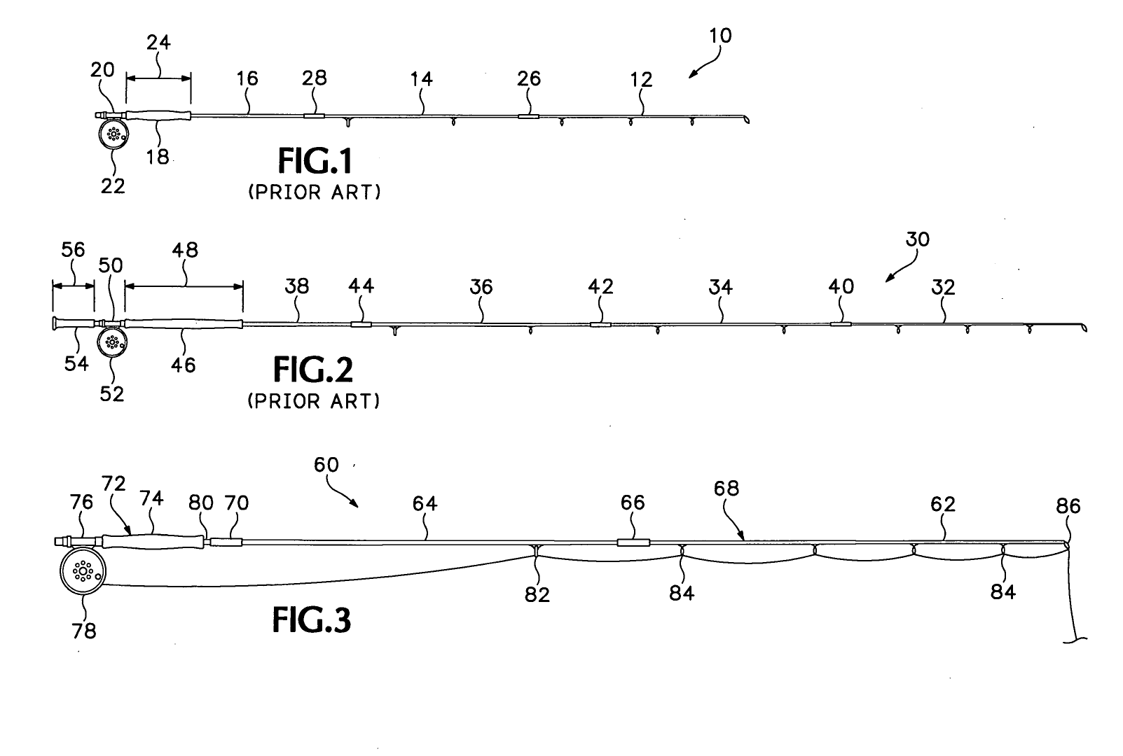

The intermediate section 64 includes a stripping guide 82 located at a conventional distance, such as 26 to 28 inches, from the reel seat 76 when the short rear section 72 is mated with the forward portion 68, so that one-handed use of the rod 60 in the configuration shown in FIG. 3 is the same as use of a conventional fly rod such as the rod 10 shown in FIG. 1. Conventional line guides 84 and a rod tip guide 86 are mounted on the tip section 62.

For use in situations where it is desired to make exceptionally long casts, and in situations where insufficient space is available for a backcast, as where an angler must stand in water close to a steep or heavily vegetated riverbank while attempting to cast a fly to a distant place, the rod 60 can be converted to the Spey fly rod configuration shown in FIG. 4. This conversion is accomplished by removing the short rear end section 72 from the forward portion 68 by separating the front connector member 80 from the rear connecting member 70 of the forward portion 68, and mounting a Spey conversion rear end portion 90 onto the rear of the front portion 68. The Spey conversion rear end portion 90 is at least about two feet longer and preferably at least three feet longer or as much as four feet longer than the short rear end portion 72. The Spey conversion rear end portion 90 has a forward shaft portion 92 which may be 18 inches to 30 inches long and which includes a front connector member 94 that mates with the rear connecting member 70 of the front portion 68. A stripping line guide 96 is mounted a short distance rearward from the front connector member 94, at a distance of, for example, about 26-28 inches from a reel seat 102. A long front grip 98, whose length 100 may preferably be in the range of 12 inches to 18 inches, corresponds to the front grip 46 of the previously described Spey fly rod 30 shown in FIG. 2. The reel seat 102 corresponds to the reel seat 50 of the Spey fly rod 30 shown in FIG. 2, and a rear hand grip 104 corresponds to and may be similar to the rear hand grip 54 of the Spey fly rod shown in FIG. 2. A reel 106 may be similar to the reel 52 shown in the Spey rod illustrated in FIG. 2.

Preferably, the Spey conversion rear end portion 90 may be tapered to cooperate with the taper of the front rod portion 68 to provide the desired Spey rod action, so that the entire rod 60 in the Spey configuration shown in FIG. 4 is stiff enough to carry the loads imposed by the weight of the moving Spey line, which typically is several yards longer than a line used with a conventional fly rod held in one hand for casting, as when the rod 60 is in the configuration shown in FIG. 3. This additional amount of line, if used, may require that the reel 106 be larger than the reel 78 for best performance. If it is desired for the rod 60 to be able to be disassembled to a more compact form for carrying, as mentioned above with respect to the forward portion 68, the Spey conversion section 90 may include a rod joint 108 shown in broken line permitting it to be separated into two shorter sections 90a and 90b.

As an alternative to use of the Spey conversion rear end portion 90, a fly rod 60′ can also be converted to a configuration for Spey casting as shown in FIG. 5. The forward portion 68 of the convertible rod 60′ is of the same form as shown in FIG. 3 and FIG. 4, but instead of the Spey conversion rear end portion 90, the rod 60′ has a rear portion 109 including a Spey conversion extension section 110 mated with the rear connecting member 70 of the forward portion 68 and with a short rear end section 112 which may be in many respects similar to the short rear end portion 72. The short rear end section 112, however, includes a rear grip 114 that is removably attached to a reel seat 116. A front connector member 118 is essentially similar to the front connector member 80 of the short rear end portion 72 shown in FIG. 3.

The Spey conversion extension section 110 includes a front connector member 120 that can be mated with the rear connecting member 70 of the front rod portion 68, and also includes a rear connecting member 122 that is similar to the rear connecting member 70 and which can be mated with the front connector member 118 of the short rear end section 112. The front connector member 118 and the front connector member 120 of the extension section 110 are similar to each other, with equal diameters 124, 126, in the case of conventional sleeve type joints. The front connector member 118 of the short rear end section 112 can be fitted directly to the rear connecting member 70 of the forward portion 68, for use of the rod 60′ configured as a conventional fly rod for casting while holding the grip 128 with a single hand, and with the rear grip 114 removed from its position at the rear of the reel seat 116. The Spey conversion extension section 110 has a length 130 of about 18 inches to 36 inches, for example, so that with the rear seat 114, the short rear end section 112, and the extension section 110 joined with each other and with the front end connecting section 120 mated with the rear connecting member 70 of the front portion 68, the rod 60′ in its Spey configuration has an overall length similar to that of the rod 60 in its Spey rod configuration as shown in FIG. 4. Preferably, the Spey conversion extension section 110 is constructed in a stiff enough form to produce flexibility characteristics similar to those of the butt section of a Spey rod such as that shown in FIG. 2.

The length 132 of the grip 128 may be chosen, if desired, to be longer than the grip 74 in the short rear end portion 72 shown in FIG. 3, in order to provide hand position options on the front hand grip 128 similar to those available on the grip 98 of the Spey conversion butt section 90 shown in FIG. 4, with little or no compromise of the utility of the rod 60′ in its shorter configuration for one hand-use, without the extension section 110 and rear grip 114. Such additional length of the grip 128 facilitates gripping the rod 60′ in the longer Spey configuration with one's hands far enough apart to control the rod easily while making a Spey cast. The length 130 of the Spey conversion extension section 110 could be reduced by an amount corresponding to the additional length 132 of the grip 128 by comparison with the length of the grip 74, if desired.

As mentioned with respect to the rod 60, the forward rod portion 68 as used with the rod 60′ may be constructed as a single section or several sections connected with each other by conventional rod joints allowing the rod 60′ to be broken down to a short package to be carried more conveniently when not in use.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I claim:

1. A convertible multi-section fly rod, comprising:
(a) a forward portion including at least a tip section, said forward portion including a rear connecting member;
(b) a short first rear end portion including a single-hand grip, a reel seat located behind said single-hand grip, and a first front connector member mateable with said rear connecting member to form an assembled fly rod having a first length; and
(c) a second rear end portion, longer than said short first rear end portion and including a front hand grip greater in length than said single-hand grip, a reel seat located behind said front hand grip, a rear hand grip located behind said reel seat, and a rod shaft extension portion extending forward from said front hand grip and having a second front connector member mateable with said rear connecting member to form an assembled Spey rod having a second length significantly greater than said first length, whereby said fly rod is convertible between a first configuration suitable for conventional one-handed flycasting and a significantly longer configuration suitable for two-handed Spey casting techniques.

2. The convertible fly rod of claim 1, wherein said reel seat of said second rear end portion accepts a larger reel than can be mounted on said reel seat of said short first rear end portion.

3. The convertible fly rod of claim 1, wherein said second rear end portion is at least three feet longer than said short first rear end portion.

4. The convertible fly rod of claim 1, wherein said rod shaft portion of said second rear end portion includes a stripping guide mounted thereon.

5. The convertible fly rod of claim 1 wherein said front connector member of said short first rear end portion is located closely adjacent to said single-hand grip and said forward portion of said rod includes a primary stripping guide mounted thereon.

6. The convertible fly rod of claim 1 wherein said forward portion includes at least two releasably interconnected sections.

7. The convertible fly rod of claim 1 wherein said rod shaft extension portion of second rear end portion includes a selectively separable rod joint whereby said second rear end portion can be disassembled for transportation.

8. A convertible multi-section fly rod, comprising:
(a) a forward rod portion including at least a tip section, said forward rod portion including a rear connecting member at a rear end of said intermediate section;
(b) a short rear end portion including a front hand grip, a reel seat behind said front hand grip, and a front connector member removably mated with said rear connecting member of said forward portion to form a configuration suitable for conventional single-handed casting; and
(c) a conversion extension section including a respective joint member at each of a pair of opposite ends thereof, said respective joint members being selectively mateable respectively with said rear connecting member of said forward portion and said front connector member of said short rear end portion to mount said conversion extension section between said short rear end portion and said forward portion; and
(d) a rear hand grip removably attachable to said short rear end portion behind said reel seat thereof, whereby said fly rod is configured suitably for use of two-handed Spey casting techniques when said conversion section and extension section and said rear hand grip are thus included.

9. The convertible fly rod of claim 8 wherein said conversion extension section is at least three feet long.

10. The convertible fly rod of claim 8 wherein said forward rod portion includes at least one intermediate section, each said intermediate section and said tip section being interconnected with one another by a respective selectively separable rod joint.
